(19) United States
(12) Patent Application Publication
(10) Pub. No.: US 2019/0176304 A1
(43) Pub. Date: Jun. 13, 2019

(54) TORQUE WRENCH ADAPTER

(71) Applicant: MAN Energy Solution SE, Augsburg (DE)

(72) Inventors: Peter DRUCKMILLER, Kutzenhausen (DE); Andreas THOMA, Langenneufnach (DE)

(21) Appl. No.: 16/327,739

(22) PCT Filed: Mar. 17, 2017
(86) PCT No.: PCT/EP2017/056335

§ 371 Date: Feb. 22, 2019

(30) Foreign Application Priority Data
Aug. 25, 2016 (DE) 10 2016 215 989.5

(51) Int. Cl. B25B 23/00; B25B 13/48

(52) U.S. Cl. CPC B25B 23/0028; B25B 13/481

(57) ABSTRACT

A torque wrench adapter attaching for coupling an open-ended wrench insert to a torque wrench, having a first section, which is used to attach the torque wrench adapter to an open-ended wrench insert, and having a second section which is used to attach the torque wrench adapter to a torque wrench. The first section and the second section are connected to each other in an articulated manner via a joint in such a way that the same can be displaced relative to each other about a pivot axis of the joint.

### CROSS REFERENCE TO RELATED APPLICATIONS

This is a U.S. national stage of application No. PCT/EP2017/056335, filed on Mar. 17, 2017. Priority is claimed on German Application No. 10 2016 215 989.5, filed Aug. 25, 2016, the content of which is incorporated herein by reference.

### BACKGROUND OF THE INVENTION

### 1. Field of the Invention

The invention relates to a torque wrench adapter and an arrangement consisting of a torque wrench adapter, an insert open-end wrench, and a torque wrench.

### 2. Description of the Prior Art

Torque wrenches as well as insert open-end wrenches that can be coupled to a torque wrench are thoroughly known from practice. Accordingly, an insert open-end wrench can be inserted into a recess of a torque wrench via a projection connecting the insert open-end to the torque wrench.

From practice, a multiplicity of application cases are known, in which screw connections have to be manipulated with a torque wrench or with an insert open-end wrench inserted in a torque wrench, which are difficult to access. Screw connections have to be manipulated on ships' engines with a torque wrench or with an insert open-end wrench connected to the torque wrench, which are accessible with conventional torque wrenches only after prior disassembly of fuel pipes so far that the same can be securely manipulated with a conventional torque wrench.

### SUMMARY OF THE INVENTION

An object of one aspect of the present invention is based on creating a torque wrench adapter.

The torque wrench adapter according to one aspect of the invention serves for connecting an insert open-end wrench to a torque wrench. The adapter comprises a first section, which serves for connecting the torque wrench adapter to an insert open-end wrench, and a second section, which serves for tying the torque wrench adapter to a torque wrench, wherein the first section and the second section are connected to one another via a joint in such a manner that the same can be moved relative to one another about a pivot axis of the joint.

With the invention present here, a torque wrench adapter is proposed for the first time, which can be placed between an insert open-end wrench and a torque wrench, and which allows a relative displacement about a pivot axis of a joint between the insert open-end wrench and the torque wrench. By way of this, screw connections in particular with difficult access can also be securely manipulated or handled, in particular even without prior disassembly of otherwise interfering components.

According to an advantageous further development, the first section comprises a main body which at a first end comprises a recess for an insert open-end wrench, and which at a second end is connected to the second section in an articulated manner via the joint. The second section comprises a main body, which at a first end comprises a projection for a torque wrench, and which at a second end is connected to the first section in an articulated manner via the joint. The joint is formed between the second end of the first section and the second end of the second section. Such a torque wrench adapter allows a simple attachment of the insert open-end wrench to the torque wrench adapter and a simple attachment of the torque wrench to the torque wrench adapter.

According to an advantageous further development, leg-like projections located opposite one another are formed at the second end of the first section, between which the second end of the second section is positioned, wherein the pivot axis of the joint extends through the two legs of the second end of the first section and through the second end of the second section arranged between the same. The pivot axis of the joint preferentially runs perpendicularly to the second end of the second section arranged between the legs. By way of this, forces or moments to be exerted via the torque wrench can be securely transmitted to the insert open-end wrench, namely by bracing on the leg-like projections of the first section of the torque wrench adapter according to one aspect of the invention.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a perspective view of a torque wrench adapter;

FIG. 2: is a plan view of the torque wrench adapter of FIG. 1;

FIG. 3: is a lateral view of the torque wrench adapter of FIGS. 1 and 2; and

FIG. 4: is the torque wrench adapter of FIGS. 1 to 3 together with an insert open-end wrench and a torque wrench.

### DETAILED DESCRIPTION OF THE PRESENTLY PREFERRED EMBODIMENTS

The invention relates to a torque wrench adapter and to an arrangement consisting of a torque wrench adapter, an insert open-end wrench, and a torque wrench.

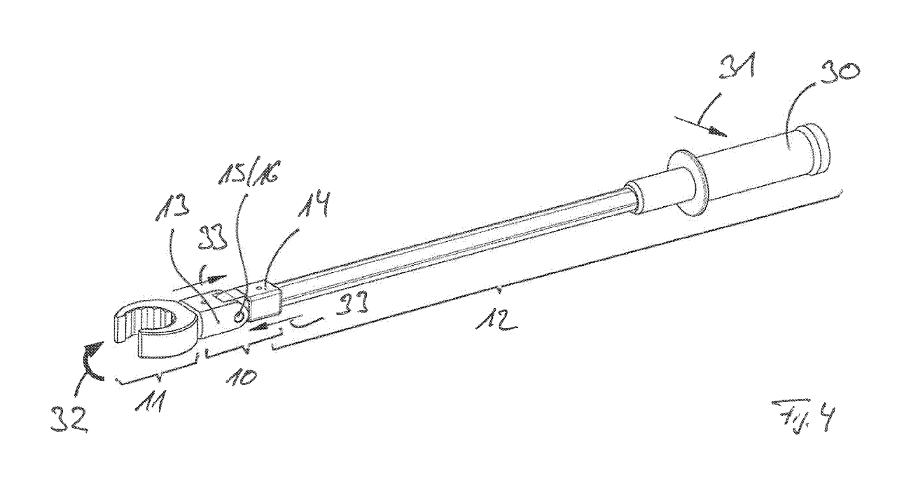

FIGS. 1 to 3 show different views of a torque wrench adapter 10 according to the invention. FIG. 4 shows an arrangement consisting of the torque wrench adapter 10 of FIGS. 1 to 3, an inset open-end wrench 11 connected to the torque wrench adapter 10, and a torque wrench 12 that is likewise connected to the torque wrench adapter 10.

The torque wrench adapter 10, which serves for the attachment of the insert open-end wrench 11 to the torque wrench 12 subject to the intermediate arrangement of the torque wrench adapter 10, comprises sections that are connected to one another in an articulated manner, namely via a first section 13 and a second section 14, which are connected to one another in an articulated manner.

The first section 13 serves for attaching the torque wrench adapter 10 to the insert open-end wrench 11, whereas the second section 14 of the torque wrench adapter 10 serves for attaching the torque wrench adapter 10 to the torque wrench 12. The first section 13 and the second section 14 are connected to one another in an articulated manner via a joint 15, namely in such a manner that the same are displaceable relative to one another about a pivot axis 16 of the joint 15, i.e. in the manner of a hinge.

The first section 13 of the torque wrench adapter 10 comprises a main body 17. The main body 17 comprises a recess 19 for the insert open-end wrench 11 at a first end 18. At a second end 20 of the first section 13, the same is connected to the second section 14 of the torque wrench adapter 10 in an articulated manner via the joint 15.

The second section 14 of the torque wrench adapter 10 likewise comprises a main body 21, which at a first end 22 comprises a projection 23 for a torque wrench, wherein via this projection 23 the torque wrench adapter 10 can be coupled to the torque wrench 12. At a second end 24, the second section 14 of the torque wrench adapter 10 is connected to the second end 20 of the first section 13 in an articulated manner, namely via the joint 15.

Accordingly, the joint 15 is formed between the two second ends 20, 24 of the two sections 13, 14 of the torque wrench adapter 10 adjoining one another and located opposite one another.

At the second end 20 of the first section 13 of the torque wrench adapter 10, leg-like projections 25 located opposite one another are formed. The second end 24 or a projection 26 of the second section 14 of the torque wrench adapter 10 formed at the second end 24 is positioned between the leg-like projects 25. The two legs 25 of the second end 20 of the first section 13 located opposite one another delimit a recess 27, into which the project 26 of the second section 14 of the torque wrench adapter 10 formed at the second end 24 engages.

The pivot axis 16 of the joint 15, via which the two sections 13, 14 of the torque wrench adapter 10 are connected to one another hinge-like in an articulated manner, extends through the two legs 25 of the second end 20 of the first section 13 and through the projection 26 formed on the second end 24 of the second section 14, which is arranged between the two legs 25. Here, this pivot axis 16 of the joint 15 runs perpendicularly to the two legs 25 at the second end 20 of the first section 13 and perpendicularly to the projection 26 formed at the second end 24 of the second section 23. The pivot axis 16 of the joint 15 runs perpendicularly to the longitudinal direction 34 of the two sections 13, 14 of the torque wrench adapter 10.

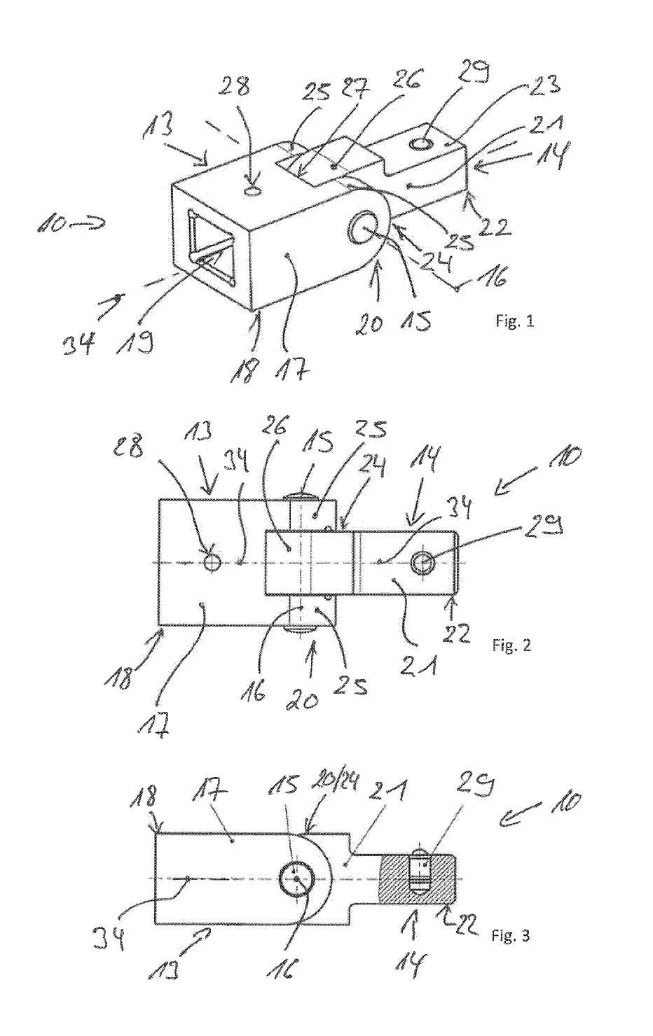

As is best evident from FIGS. 1 and 2, an engagement recess interacting with an engagement element of the insert open-end wrench 11 is formed on the first section 13 of the torque wrench adapter 10. In particular when the insert open-end wrench 11 is inserted with a corresponding projection into the recess 19 in the first section 13 of the torque wrench adapter 10, this engagement element of the open-end wrench 11 engages in the engagement recess 28 at the first section 13 of the torque wrench adapter 10, in order to thereby detachably fix the insert open-end wrench 11 in place on the torque wrench adapter 10.

On the second section 14 of the torque wrench adapter 10, namely in the region of the projection 23 formed at the first end 22 of the same, an engagement element 29 is formed, which interacts with a corresponding engagement recess in the torque wrench 12, namely in particular when the torque wrench adapter 10 with the projection 23 at the first end 22 of the second section 14 is inserted into a corresponding recess in the torque wrench adapter 12. In this case, the engagement element 29 then engages in a corresponding engagement recess of the torque wrench 12. The engagement element 29 is a spring-actuated ball. For disconnecting the connection between the torque wrench adapter 10 and the torque wrench 12, the engagement element 29, namely the ball of the same, merely has to be moved against the spring force of a spring element acting on the ball downwards and out of the corresponding engagement recess in the torque wrench 12 in order to subsequently be able to disconnect the torque wrench adapter 10 from the torque wrench 12.

Because of the fact that the torque wrench adapter 10 comprises the hinge-like joint 15, the insert open-end wrench 11 in the arrangement of FIG. 4 can be displaced in its relative orientation to the torque wrench 10 in a single degree of freedom which is defined by the pivot axis 16 of the joint 15, so that with the arrangement of FIG. 4 screw connections with difficult access can also be handled.

When tightening or unscrewing a screw connection with the help of the arrangement of FIG. 4, a force or a moment is exerted on a handle 30 of the torque wrench 12 in the direction of the arrow 31. This force or this moment 31 braces itself on the legs 25 of the first section 13 of the torque wrench adapter 10 and can thus be transmitted from the second section 14 of the torque wrench adapter 10 to the first section 13 of the torque wrench adapter 10 and thus ultimately to the insert open-end wrench 11, in order to provide a moment 32 on the same. The bracing of the moment exerted on the handle 31 on the legs 25 of the first section 13 of the torque wrench adapter 10 is visualised in FIG. 4 by arrows 33.

Accordingly, a torque wrench adapter 10 is proposed with the invention, which can be connected between the insert open-end wrench 11 and the torque wrench 12 in order to thus allow a hinge-like or articulated displacement of the insert open-end wrench 11 relative to the torque wrench 12. By way of this, even screw connections with difficult access can be easily and securely manipulated, namely in such a manner that on the same a torque for tightening or unscrewing the same can be reliably exerted, namely without prior disassembly of assemblies which restrict the accessibility of the screw connection to be manipulated.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A torque wrench adapter configured to couple an insert open-end wrench to a torque wrench, comprising:
a first section, configured to attach the torque wrench adapter to the insert open-end wrench;
a second section, configured to attach the torque wrench adapter to the torque wrench; and
a joint configured to articulatedly connect the first section and the second section such that the first section and the second section are displaceable relative to one another about a pivot axis of the joint.

11. The torque wrench adapter according to claim 10, wherein the first section comprises:
a first section main body;
a first end of the first section main body defines a recess for a section of the insert open-end wrench;
a second end of the first section main body is connected to the second section via the joint.

12. The torque wrench adapter according to claim 11, wherein the second section comprises:
a second section main body;
a projection arranged at a first end of the second section main body configured to interact with the torque wrench; and
a second end of the second section main body is connected to the first section via the joint.

13. The torque wrench adapter according to claim 12, wherein the joint is formed between the second end of the first section and the second end of the second section.

14. The torque wrench adapter according to claim 13, further comprising:
at least two leg-like projections, located opposite each another, are formed on the second end of the first section, between which the second end of the second section is positioned,
wherein the pivot axis of the joint extends through the at least two leg-like projections and through the second end of the second section arranged between the at least two leg-like projections.

15. The torque wrench adapter according to claim 14, wherein the pivot axis of the joint is perpendicularly to:
the at least two leg-like projections of the second end of the first section and
the second end of the second section arranged between the at least two leg-like projections.

16. The torque wrench adapter according to claim 10, wherein the first section comprises an engagement recess configured to interact with an engagement element of the insert open-end wrench.

17. The torque wrench adapter according to claim 10, wherein the second section comprises an engagement element configured to interact with an engagement recess of the torque wrench.

18. The torque wrench adapter according to claim 10, wherein the second section comprises:
a second section main body;
a projection arranged at a first end of the second section main body configured to interact with the torque wrench; and
a second end of the second section main body is connected to the first section via the joint.

19. The torque wrench adapter according to claim 15, wherein at least on of:
the first section comprises an engagement recess configured to interact with an engagement element of the insert open-end wrench; and
the second section comprises an engagement element configured to interact with an engagement recess of the torque wrench.

20. An arrangement comprising:
an insert open-end wrench;
a torque wrench; and
a torque wrench adapter comprising:
a first section, configured to attach the torque wrench adapter to the insert open-end wrench;
a second section, configured to attach the torque wrench adapter to the torque wrench; and
a joint configured to articulatedly connect the first section and the second section such that the first section and the second section are displaceable relative to one another about a pivot axis of the joint.
